(19) United States
(12) Patent Application Publication
(10) Pub. No.: US 2011/0053134 A1
(43) Pub. Date: Mar. 3, 2011

(54) SENSOR-BASED TEACHING AID ASSEMBLY

(75) Inventors: Ho Youl JUNG, Daejeon (KR); Chan Yong Park, Daejeon (KR); Min Ho Kim, Daejeon (KR); Soo Jun Park, Seoul (KR); Seon Hee Park, Daejeon (KR)

(73) Assignee: Electronics and Telecommunications Research Institute, Daejon (KR)

(21) Appl. No.: 12/822,851

(22) Filed: Jun. 24, 2010

(30) Foreign Application Priority Data
Sep. 2, 2009 (KR) 10-2009-0082468

(51) Int. Cl. G09B 7/00

(52) U.S. Cl. 434/362

(57) ABSTRACT

A sensor-based teaching aid assembly includes: a plurality of teaching aid parts having a unique ID, detecting their location and adjacent teaching aid parts through an internal sensor, and transmitting result data to outside; and an information processing terminal displaying an image of an assembly target structure, analyzing the data received from the plurality of teaching aid parts to evaluate a completion degree of the structure assembled by the plurality of teaching aid parts, and displaying the evaluation results.

### CROSS-REFERENCE TO RELATED APPLICATIONS

This application claims the priority of Korean Patent Application No. 10-2009-0082468 filed on Sep. 2, 2009, in the Korean Intellectual Property Office, the disclosure of which is incorporated herein by reference.

### BACKGROUND OF THE INVENTION

1. Field of the Invention

The present invention relates to a sensor-based teaching aid assembly and, more particularly, to a sensor-based teaching aid assembly that can interact with users and systematically evaluate and manage users' learning results by merging IT technology with a conventional passive, stationary teaching aid assembly.

2. Description of the Related Art

As people become increasingly interested in improvements in education, a variety of teaching aids are being developed to aid in the development of the intelligence of small children such as toddlers or preschoolers. In particular, teaching aid assemblies are commonly used to develop small children's understanding of objects through the process of assembling teaching aids in various shapes and subsequently disassembling the assembled teaching aids.

However, the related art teaching aid assemblies merely allow toddlers or preschoolers to fit the teaching aid parts or the like according to a predetermined frame or assemble the teaching aid parts upon seeing a text book with complete shapes. Thus, learning through the teaching aid assemblies is done passively or statically, and systematic evaluations or management of the toddlers' or preschoolers' learning results using the teaching aid assemblies are not properly made.

Thus, in an effort to solve the problem, a virtual teaching aid assembly has been developed. When the virtual teaching aid assembly is displayed on the screen of a terminal such as a computer or the like, toddlers or preschoolers may shift teaching aid parts to assemble them on the screen. However, the virtual teaching aid assembly lacks actuality and is not suitable to properly transfer sensitivity through a tactile sense as compared with real teaching aid assemblies.

### SUMMARY OF THE INVENTION

An aspect of the present invention provides a sensor-based teaching aid assembly that can interact with users and systematically evaluate and manage users' learning results by merging IT technology with a conventional passive, stationary teaching aid assembly.

According to an aspect of the present invention, there is provided a sensor-based teaching aid assembly including: a plurality of teaching aid parts, each having a unique ID, detecting their location and adjacent teaching aid parts through an internal sensor, and transmitting result data to the outside; and an information processing terminal displaying an image of an assembly target structure, analyzing the data received from the plurality of teaching aid parts to evaluate a completion degree of the structure assembled by the plurality of teaching aid parts, and displaying the evaluation results.

The information processing terminal may store the evaluation result and display evaluation history stored during a certain period of time. Also, the information processing terminal may display an image with respect to a physical movement that can be possibly generated by the assembled structure according to the evaluation results.

Each of the teaching aid parts may include: a position sensor sensing the position of a teaching aid part; an adjacent teaching aid part sensor sensing teaching aid parts adjacent to the teaching aid part; and a wireless communication unit transmitting signals of the position sensor and the adjacent teaching aid part sensor to the information processing terminal.

The position sensor may be implemented as a three-axis acceleration sensor or a gyroscopic sensor. The adjacent teaching aid part sensor may be implemented to sense adjacent teaching aid parts through a proximity sensor, or implemented to sense the presence or absence of adjacent teaching aid parts through infrared communications. The wireless communication unit may be implemented by a ZigBee™ or Bluetooth™ technique.

Each of the teaching aid parts may further include an internal battery for driving the position sensor and the adjacent teaching aid part sensor.

The information processing terminal may include: a wireless communication unit receiving position information of the teaching aid part and information regarding teaching aid parts adjacent to the teaching aid part; a situation analyzing unit analyzing the position information of the teaching aid part and the information regarding the teaching aid parts adjacent to the teaching aid part to recognize adjacency between the plurality of teaching aid parts, and evaluating a completion degree of an assembled structure; and a display unit displaying an image of the assembly target structure and displaying the completion degree of the structure evaluated by the situation analyzing unit.

The information processing terminal may further include: a result processing unit visualizing an image with respect to a physical movement that can be possibly generated according to the completion degree of the structure evaluated by the situation analyzing unit through the display unit.

The information processing terminal may further include: a storage unit storing an image of the assembly target structure and an image with respect to a physical movement that can be possibly generated according to whether or not the assembly target structure is complete, and the storage unit may store information regarding the completion degree of the structure evaluated by the situation analyzing unit.

The display unit may display evaluation history with respect to the completion degree of the structure during a certain period of time stored in the storage unit.

The information processing terminal may further include: a structure generating unit allowing an image of the assembly target to be directly configured by a user.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a conceptual view for explaining a sensor-based teaching aid assembly according to an exemplary embodiment of the present invention;

FIG. 2 is a detailed block diagram of an information processing terminal constituting the sensor-based teaching aid assembly according to an exemplary embodiment of the present invention; and

FIG. 3 is a detailed block diagram of a teaching aid part constituting the sensor-based teaching aid assembly according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

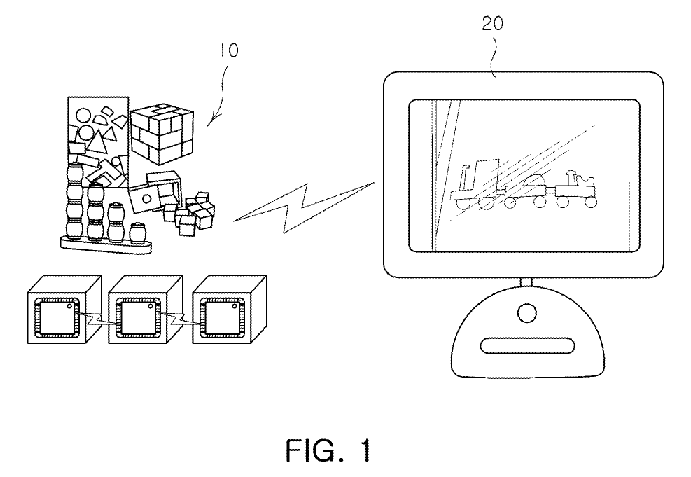

FIG. 1 is a conceptual view for explaining a sensor-based teaching aid assembly according to an exemplary embodiment of the present invention.

A sensor-based teaching aid assembly according to an exemplary embodiment of the present invention includes a plurality of teaching aid parts 10 and an information processing terminal 20.

Each of the plurality of teaching aid parts 10, including an ID assigned for identification, detects its position and that of an adjacent teaching aid part through a sensor and transmits the corresponding results to the information processing terminal 20.

The information processing terminal 20 displays an image of a structure to be assembled, to a user, processes signals received from the plurality of teaching aids 10 to evaluate the level of completion (or completeness) of the assembled structure, and stores and displays the results. Also, the information processing terminal 20 displays an image with respect to a physical movement that can be possibly generated according to whether or not the structure is complete.

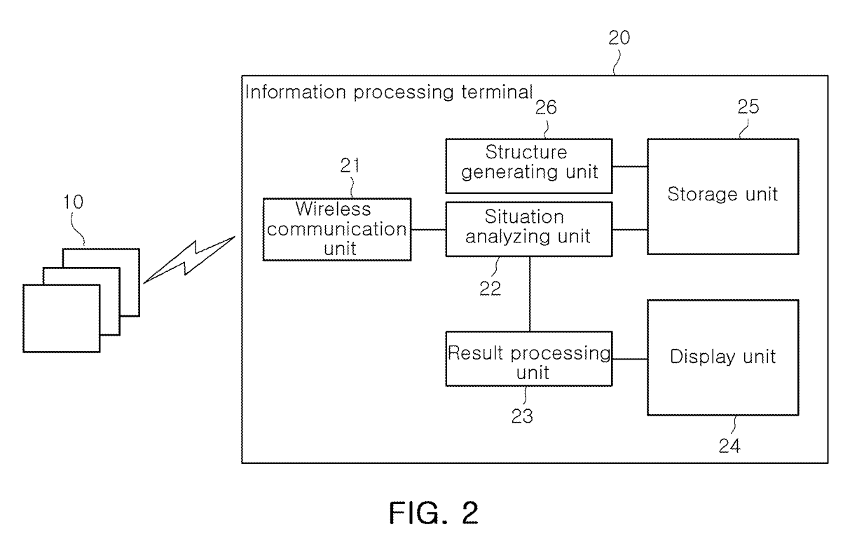

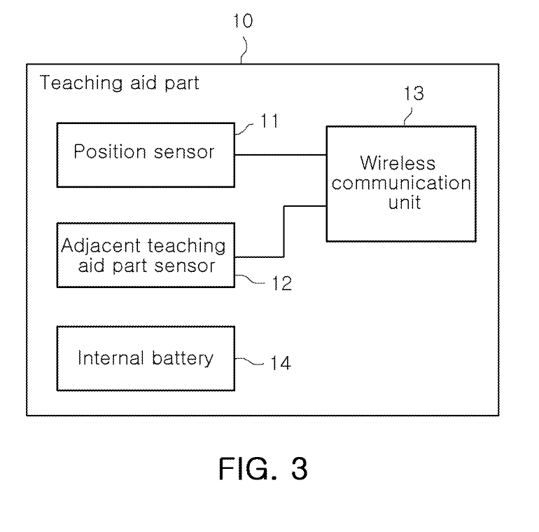

The teaching aid parts 10 and the information processing terminal 20 constituting the sensor-based teaching aid assembly according to an exemplary embodiment of the present invention will now be described in more detail with reference to FIGS. 2 and 3.

FIG. 2 is a detailed block diagram of an information processing terminal constituting the sensor-based teaching aid assembly according to an exemplary embodiment of the present invention.

The information processing terminal 20 includes a wireless communication unit 21, a situation analyzing unit 22, a result processing unit 23, a display unit 24, and a storage unit 25, and according to circumstances, the information processing terminal 20 may further include a structure generating unit 26.

The wireless communication unit 21 communicates with the plurality of teaching aid parts 10 to receive position information of a corresponding teaching aid part and information regarding teaching aid parts adjacent to the corresponding teaching aid part from the plurality of teaching aid parts 10. The wireless communication unit 21 may be implemented by a wireless communication technique such as ZigBee™, Bluetooth™, and the like.

The situation analyzing unit 22 analyzes the position information of the corresponding teaching aid part and the information regarding the adjacent teaching aid parts which have been transferred from the wireless communication unit 21 to recognize adjacency between (or among) the plurality of teaching aid parts 10, and evaluates the level of completion of an assembled structure based on the analyzed adjacency. For example, the situation analyzing unit 22 analyzes the adjacency of the teaching aid parts 10 and compares the analyzed adjacency of the teaching aid parts 10 to teaching aid part adjacency situation information stored in the storage unit 25 when the corresponding structure is complete, thus evaluating the level of completion of the actually assembled structure.

The result processing unit 23 visualizes a physical movement that can be possibly generated according to the level of completion of the structure evaluated by the situation analyzing unit 22 through the display unit 24. In detail, when a structure such as a train or a car is assembled from the plurality of teaching aid parts 10, the result processing unit 23 recognizes whether or not the structure is complete, according to the evaluated level of completion of the situation analyzing unit 22. Thereafter, when the structure is complete, the result processing unit 23 displays a normal physical movement of the corresponding structure, e.g., an image in which the train or car starts to move. Meanwhile, if the structure is incomplete, the result processing unit 23 displays an image in which the train or car is out of order or is stopped in place, rather than moving. In this case, the image displayed according to whether or not the structure is complete may be stored in the storage unit 25.

The display unit 24 displays the image of the structure to be assembled by the user or an image regarding a physical movement that can be possibly generated according to whether or not the structure is complete. Also, the display unit 24 displays learning evaluation results such as the level of completion of the structure evaluated by the situation analyzing unit 22, structure completion level history, and the like, during a certain period of time stored in the storage unit 25.

The storage unit 25 stores data related to the structure such as an image of the structure to be assembled by the user, information regarding a teaching aid part adjacency situation when the corresponding structure is complete, or an image regarding a physical operation that can be possibly generated according to whether or not the corresponding structure is complete, as well as data relating to a user's learning evaluation history, such as the level of completion of the structure evaluated by the situation analyzing unit 22 each time the sensor-based teaching aid is in use.

The structure generating unit 26 serves to allow the user to directly configure an image of a new structure intended to be assembled by the user when the user wants to assemble it, besides the structure stored in the storage unit 25. The structure generating unit 26 may be configured as a software language to allow the user to easily configure an image of the structure.

FIG. 3 is a detailed block diagram of a teaching aid part constituting the sensor-based teaching aid assembly according to an exemplary embodiment of the present invention.

Each teaching aid part 10 includes a position sensor 11, an adjacent teaching aid part sensor 12, a wireless communication unit 13, and an internal battery 14.

The position sensor 11, which senses the position of the teaching aid part 10, may be implemented as a 3-axis acceleration sensor or a gyroscopic sensor.

The adjacent teaching aid part sensor 12 senses teaching aid parts adjacent to the teaching aid part 10. For example, the adjacent teaching aid parts may be sensed by a proximity sensor, or the presence or absence of adjacent teaching aid parts may be sensed through infrared communication.

The wireless communication unit 13 transmits a signal generated by the position sensor 11 and the adjacent teaching aid part sensor 12, namely, position information of the teaching aid part 10 and information regarding adjacent teaching aid parts, to the information processing terminal 20. The wireless communication unit 13 may be implemented by a wireless communication technique such as ZigBee™, Bluetooth™, and the like.

The internal battery 14 is installed in each of the teaching aid parts 10 in order to drive the sensors 11 and 12 provided in each of the teaching aid parts 10.

As set forth above, according to exemplary embodiments of the invention, the sensor-based teaching aid assembly allows small children such as toddlers or preschoolers to assemble teaching aid parts while directly touching them with their hands, and therefore sensitivity can be transferred through tactile sense.

In addition, the level of completion of an assembled structure is evaluated in real time by analyzing information acquired by a position sensor and an adjacent teaching aid part sensor installed in each teaching aid part, and the results are immediately displayed, or stored an accumulated learning evaluation history during a certain period of time for a later provision. Thus, the learning results can be systematically evaluated and managed.

Moreover, because the image regarding a physical movement that can be possibly generated according to whether or not the structure by the teaching aid is complete is displayed on the screen of the terminal, active learning allowing for an interaction with the user can be made.

While the present invention has been shown and described in connection with the exemplary embodiments, it will be apparent to those skilled in the art that modifications and variations can be made without departing from the spirit and scope of the invention as defined by the appended claims.

What is claimed is:

1. A sensor-based teaching aid assembly comprising:
a plurality of teaching aid parts, each having a unique ID, detecting their location and adjacent teaching aid parts through an internal sensor, and transmitting result data to the outside; and
an information processing terminal displaying an image of an assembly target structure, analyzing the data received from the plurality of teaching aid parts to evaluate a completion degree of the structure assembled by the plurality of teaching aid parts, and displaying the evaluation results.

2. The teaching aid assembly of claim 1, wherein the information processing terminal stores the evaluation result and display evaluation history stored during a certain period of time.

3. The teaching aid assembly of claim 1, wherein the information processing terminal displays an image with respect to a physical movement that can be possibly generated by the assembled structure according to the evaluation results.

4. The teaching aid assembly of claim 1, wherein each of the teaching aid parts comprises:
a position sensor sensing the position of a teaching aid part;
an adjacent teaching aid part sensor sensing teaching aid parts adjacent to the teaching aid part; and
a wireless communication unit transmitting signals of the position sensor and the adjacent teaching aid part sensor to the information processing terminal.

5. The teaching aid assembly of claim 4, wherein the position sensor is implemented as a three-axis acceleration sensor or a gyroscopic sensor.

6. The teaching aid assembly of claim 4, wherein the adjacent teaching aid part sensor implemented to sense adjacent teaching aid parts through a proximity sensor.

7. The teaching aid assembly of claim 4, wherein the adjacent teaching aid sensor is implemented to sense the presence or absence of adjacent teaching aid parts through infrared communications.

8. The teaching aid assembly of claim 4, wherein the wireless communication unit is implemented by a ZigBee™ or Bluetooth™ technique.

9. The teaching aid assembly of claim 4, wherein each of the teaching aid parts further comprises: an internal battery for driving the position sensor and the adjacent teaching aid part sensor.

10. The teaching aid assembly of claim 1, wherein the information processing terminal comprises:
a wireless communication unit receiving position information of the teaching aid part and information regarding teaching aid parts adjacent to the teaching aid part;
a situation analyzing unit analyzing the position information of the teaching aid part and the information regarding the teaching aid parts adjacent to the teaching aid part to recognize adjacency between the plurality of teaching aid parts, and evaluating a completion degree of an assembled structure; and
a display unit displaying an image of the assembly target structure and displaying the completion degree of the structure evaluated by the situation analyzing unit.

11. The teaching aid assembly of claim 10, wherein the information processing terminal further comprises: a result processing unit visualizing an image with respect to a physical movement that can be possibly generated according to the completion degree of the structure evaluated by the situation analyzing unit through the display unit.

12. The teaching aid assembly of claim 10, wherein the information processing terminal further comprises: a storage unit storing an image of the assembly target structure and an image with respect to a physical movement that can be possibly generated according to whether or not the assembly target structure is complete.

13. The teaching aid assembly of claim 12, wherein the storage unit stores information regarding the completion degree of the structure evaluated by the situation analyzing unit.

14. The teaching aid assembly of claim 13, wherein the display unit displays evaluation history with respect to the completion degree of the structure during a certain period of time stored in the storage unit.

15. The teaching aid assembly of claim 10, wherein the information processing terminal further comprises: a structure generating unit allowing an image of the assembly target to be directly configured by a user.
